(19) United States
(12) Patent Application Publication
(10) Pub. No.: US 2007/0162878 A1
(43) Pub. Date: Jul. 12, 2007

(54) Method for automatically displaying data in wireless terminal

(75) Inventor: Jung-Seung Lee, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd.

(21) Appl. No.: 11/647,008

(22) Filed: Dec. 28, 2006

(30) Foreign Application Priority Data
Dec. 29, 2005 (KR) 2005-133750

(51) Int. Cl. G06F 3/14; G06F 17/00

(52) U.S. Cl. 715/864; 715/517

(57) ABSTRACT

A method for automatically displaying data in a wireless terminal, the method includes displaying selected data in the wireless terminal; when the data are enlarged and displayed as partial data, extracting an automatic display value for displaying the partial data enlarged through automatic shift; and automatically displaying the automatically shifted and enlarged partial data through the automatic display value.

### PRIORITY

This application claims priority to an application entitled “Method For Automatically Displaying Data In Wireless Terminal” filed in the Korean Intellectual Property Office on Dec. 29, 2005 and assigned Serial No. 2005-133750, the contents of which are incorporated herein by reference.

### BACKGROUND OF THE INVENTION

1. Field of the Invention

The present invention relates generally to a method for automatically displaying data in a wireless terminal, and in particular, to a method for automatically displaying data in a wireless terminal, in which an entire document can be displayed while automatically shifting and displaying a partial section of the document that is enlarged and displayed in the wireless terminal.

2. Description of the Related Art

Presently, a wireless terminal has a file viewer function for displaying a document. If the user of the wireless terminal selects and executes a document which the user wants to view through the file viewer function, the first page of the selected document is displayed on the display unit of the wireless terminal.

However, when the document is completely displayed, the user cannot read the document because characters within the document are shown like dots. In such a case, the user can enlarge the font size within the document through an enlargement key. Further, when the document is enlarged through the enlargement key, the document is extremely and partially enlarged and displayed on the display unit.

Therefore, the user must shift and display the partially enlarged document by inputting direction (i.e., up/down/left/right) keys several times in order to read a full page of the document.

### SUMMARY OF THE INVENTION

Accordingly, the present invention has been made to solve the above-mentioned problems occurring in the conventional art, and an object of the present invention is to provide a method for automatically displaying data in a wireless terminal, in which an entire document can be displayed while automatically shifting and displaying a partial section of the document enlarged and displayed in the wireless terminal.

In accordance with one aspect of the present invention, there is provided a method for automatically displaying data in a wireless terminal, the method includes displaying selected data in the wireless terminal; when the data are enlarged and displayed as partial data, extracting an automatic display value for displaying the partial data enlarged through automatic shift; and automatically displaying the automatically shifted and enlarged partial data through the automatic display value.

In accordance with another aspect of the present invention, there is provided a method for automatically displaying document data in a wireless terminal, the method includes enlarging a selected document in the wireless terminal and displaying the enlarged partial section of the document; extracting an automatic display value required for reading a longest line in the enlarged partial section of the document; and automatically displaying the enlarged partial section of the document through automatic shift by means of the automatic display value.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a wireless terminal according to the present invention;

FIG. 2 is a flow chart illustrating a process for automatically displaying document data in a wireless terminal according to the present invention;

FIG. 3 is a flow chart illustrating a process for setting automatic display in FIG. 2; and

FIG. 4 is a flow chart illustrating a process for automatically displaying a document through an automatic display value in FIG. 3.

### DETAILED DESCRIPTION OF THE PREFERRED EMBODIMENTS

Preferred embodiments of the present invention will be described in detail herein below with reference to the accompanying drawings. The same reference numerals are used to designate the same elements as those shown in other drawings. In the following description, well-known functions or constructions are not described in detail since they would obscure the invention in unnecessary detail.

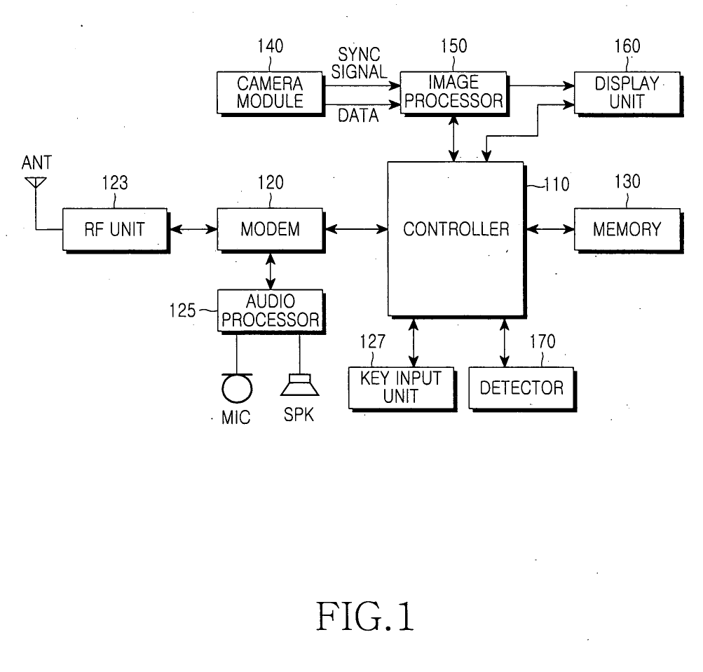

FIG. 1 is a block diagram illustrating the construction of a wireless terminal equipped with a camera according to the present invention.

Referring to FIG. 1, a Radio Frequency (RF) unit 123 performs a wireless communication function of the wireless terminal. The RF unit 123 includes an RF transmitter (not shown) for up-converting and amplifying the frequency of transmitted signals, an RF receiver (not shown) for low-noise amplifying received signals and down-converting the frequency of the received signals, etc. A modem 120 includes a transmitter (not shown) for coding and modulating the transmitted signals, a receiver (not shown) for demodulating and decoding the received signals, etc. An audio processor 125 can include a codec (not shown). The codec (not shown) includes a data codec (not shown) for processing packet data, etc., and an audio codec (not shown) for processing audio signals such as voice. The audio processor 125 converts digital audio signals received through the modem 120 into analog signals through the audio codec for reproduction, or converts analog audio signals generated from a microphone into digital audio signals through the audio codec and transmits the digital audio signals to the modem 120. The codec can be separately provided or it can be included in a controller 110.

A memory 130 can include a program memory and a data memory. The program memory can store programs for controlling general operations of the wireless terminal, and control programs for automatically shifting and displaying partial data enlarged in the automatic display mode of the wireless terminal according to the present invention. The data memory temporarily stores data generated during the execution of the programs. Further, the memory 130 can store a preset automatic display value according to the present invention.

The controller 110 performs a function of controlling the general operations of the wireless terminal, which can also include the modem 120 and the codec. According to the present invention, in the automatic display setup mode of the wireless terminal, the controller 110 controls a detector 170 for extracting an automatic display value for displaying partial data that have been automatically shifted and enlarged. Further, according to the present invention, in the automatic display mode of the wireless terminal, the controller 110 controls the display of the partial data that have been automatically shifted and enlarged through the automatic display value input by the detector 170.

The detector 170 extracts the automatic display value for displaying the partial data that have been automatically shifted and enlarged in the automatic display setup mode under the control of the controller 110, and outputs the extracted automatic display value to the controller 110. The automatic display value includes the total number “Max Number (MN)” of inputs of a predetermined shift key for displaying a predetermined line of data, e.g., one of the longest lines, the total shift time “Total Time (TT)”, and Average Time (AT), for which the predetermined shift key is input, which is obtained through the max number of inputs and the total time.

A camera module 140 includes a camera sensor for photographing image data and converting photographed optical signals into electrical signals, and a signal processor for converting analog image signals photographed by the camera sensor into digital data. It is assumed that the camera sensor is a Charge-Coupled Device (CCD) sensor. The signal processor can be realized by a Digital Signal Processor (DSP). Further, the camera sensor can be integrated with the signal processor, or can also be constructed separately from the signal processor.

An image processor 150 generates screen data for displaying image signals output from the camera module 140. The image processor 150 processes the image signals, which are output from the camera module 140, by the frame, and outputs the frame image data according to the characteristics and sizes of a display unit 160. The image processor 150 includes an image codec, compresses the frame image data, which is displayed on the display unit 160, by a predetermined scheme, or restores the compressed frame image data into original frame image data. The image codec can include, but is not limited to, a JPEG codec, an MPEG4 codec, and a wavelet codec. It is assumed that the image processor 150 has an On Screen Display (OSD) function, which can output on screen display data according to displayed screen sizes under the control of the controller 110.

The display unit 160 displays the image signals output from the image processor 150 on a screen, and displays user data output from the controller 110. The display unit 160 can use a Liquid Crystal Display (LCD). In this case, the display unit 160 can include, but not limited to, an LCD controller, a memory capable of storing image data, an LCD display device. When the LCD has a touch screen function, the display unit 160 can also operate as an input unit. The display unit 160 can display selected data as enlarged partial data, and display the partial data that have been automatically shifted and enlarged in the automatic display mode according to the present invention.

A key input unit 127 includes keys for inputting numeral and character information and function keys for setting various functions. Further, the key input unit 127 can have direction (i.e., up/down/left/right) keys for shifting and displaying the enlarged partial data according to the present invention.

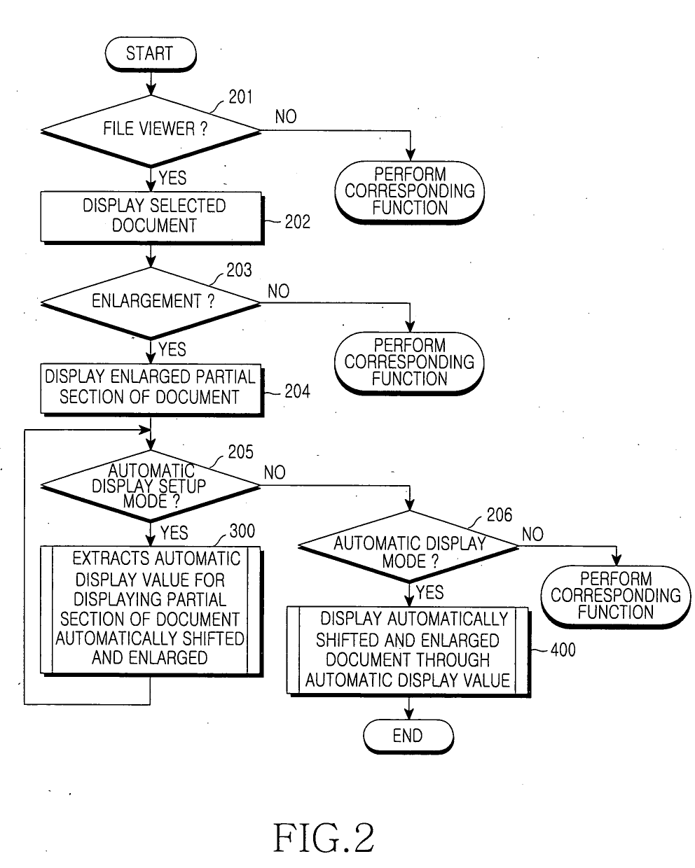

Hereinafter, an operation for automatically displaying the data in the wireless terminal as described above will be described in detail with reference to FIGS. 2 to 4. Referring to FIGS. 2 to 4 of the present invention, document data of data, which can be displayed through the automatic display mode in the wireless terminal, will be described as an example herein. Further, an automatic display method of document data in the present invention, in which characters and numerals written from left to right are displayed line by line, will be described as an example herein.

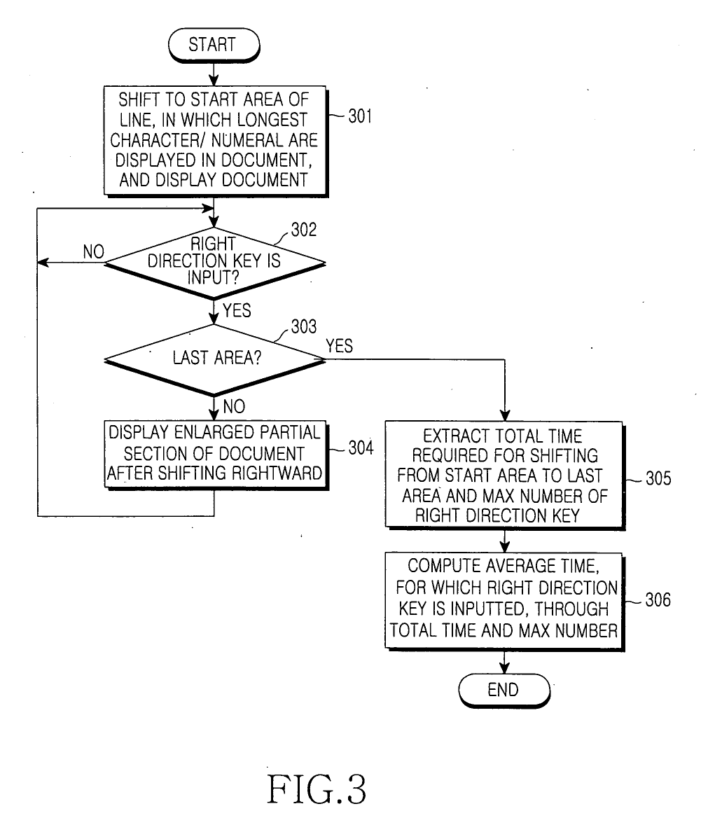

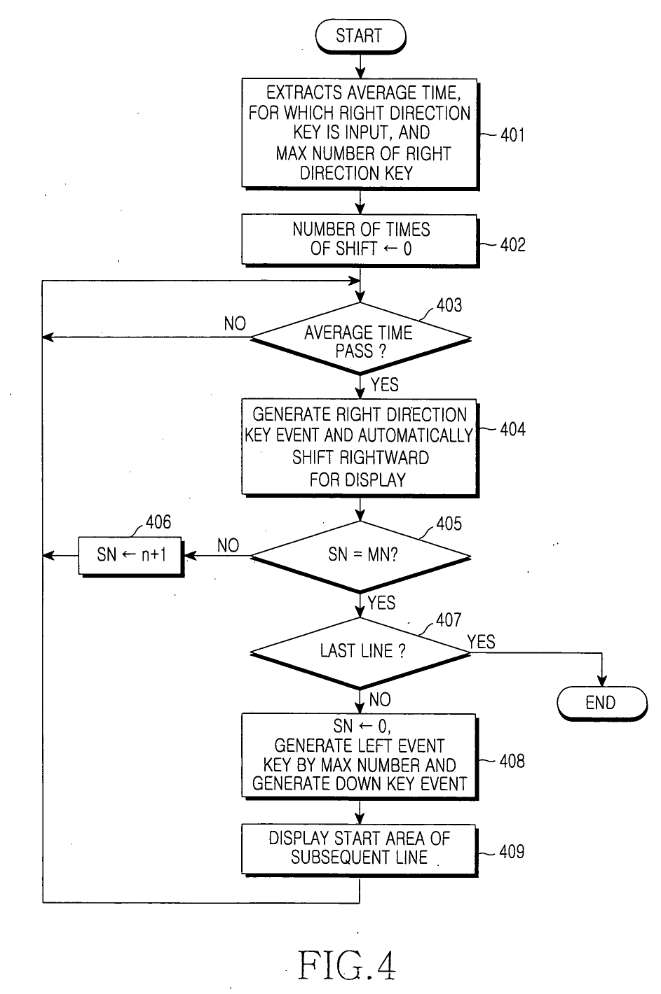

FIG. 2 is a flow chart illustrating a process for automatically displaying document data in the wireless terminal according to the present invention. FIG. 3 is a flow diagram illustrating a process for setting automatic display in FIG. 2, and FIG. 4 is a flow diagram illustrating a process for automatically displaying a document through an automatic display value in FIG. 3.

Referring to FIG. 2, if a file viewer is selected from the menu of the wireless terminal, the controller 110 detects the selection of the file viewer and displays files stored in the memory 130, in step 201. If a predetermined file is selected from the displayed files, the controller 110 detects the selection of the file and displays the selected file, in step 202. In step 202, the first page of a document with the selected file is completely displayed on the display unit 160. In a state in which the entire first page within the document has been displayed, if an enlargement key is input, the controller 110 detects the input of the enlargement key in step 203. In step 204, the controller 110 enlarges the document by a predetermined size so as to correspond to the number of times of inputs of the enlargement key, and simultaneously displays the enlarged partial section of the document on the display unit 160.

In a state in which the enlarged partial section of the document has been displayed on the display unit 160, if an automatic display setup mode is selected, the controller 110 detects the selection of the automatic display setup mode in step 205. In step 300, the controller 110 extracts an automatic display value for displaying the partial section of the document, which has been automatically shifted and enlarged, through the detector 170.

Referring to FIG. 3, a process for extracting the automatic display value of step 300 will be described in detail. In the automatic display setup mode, the controller 110 controls the detector 170 to set a parameter for extracting the automatic display value.

In the automatic display setup mode, if a user shifts a cursor to a start area of a predetermined line within the currently displayed document through input of direction keys (i.e., up/down/left/right), e.g. a start area of the longest line full of displayed characters/numerals, the controller 110 detects the shift of the cursor and displays the enlarged partial section of the document corresponding to the start area on the display unit 160, in step 301. The start area represents an area for displaying the enlarged partial section of the document including the first character/numeral of one line.

The shift to the start area of the longest line can be displayed by a user or automatically displayed by the controller 110. In a state where the enlarged partial section of the document, which corresponds to the start area of the longest line, has been displayed, if a right direction key is input in order to read characters/numerals written from left to right, the controller 110 detects the input of the right direction key in step 302 and determines if the current area displayed on the display unit 160 is the last area of the longest line in step 303. The last area represents an area for displaying the enlarged partial section of the document including the last character/numeral of one line.

As a result of the determination, if the current area is not the last area, the controller 110 shifts the cursor by the predetermined number of pixels according to the input of the right direction key, does not display left characters/numerals displayed by the predetermined number of pixels, and displays right characters/numerals having not been displayed, thereby displaying the corresponding enlarged partial section of the document, in step 304.

Through repetition of steps 302 to 304, a user can read the enlarged characters/numerals displayed on the longest line while inputting the right direction key. If the last area of the longest line is reached during the repetition of the steps, the controller 110 detects that the last area has been reached in step 303, and controls the detector 170 to extract a parameter for obtaining an automatic display value in step 305. In step 305, the detector 170 extracts and stores both the max number, by which a user has inputted the right direction key in order to read the characters/numerals from the first area to the last area of the longest line, and the total time required for shifting from the start area to the last area. Then, in step 306, the controller 110 computes average time, for which the right direction key is inputted, by dividing the total time by the max number, and stores the average time.

As described above, if the automatic display value for automatically displaying the current document is extracted through the process of FIG. 3 and then the automatic display mode is set, the controller 110 detects the setup of the automatic display mode in step 206, and displays the automatically shifted and enlarged document through the automatic display value extracted in FIG. 3, in step 400.

Hereinafter, referring to FIG. 4, a process for displaying the automatically shifted and enlarged document through the automatic display value of step 400 will be described in detail herein.

Referring to FIG. 4, in the automatic display mode, if a user shifts a cursor to a predetermined area of a predetermined line for completely reading the document by means of automatic display through input of the direction shift keys, e.g. the start area of the first line of the document, the controller 110 detects the shift of the cursor and displays the enlarged partial section of the document corresponding to the start area of the first line.

The shift to the start area by means of the automatic display in order to read the document can be accomplished through the input of the direction shift keys by the user or automatically accomplished by the controller 110. Further, after the shift to the start area by the user or the controller 110, switch to the automatic display mode is possible.

In the automatic display mode, the controller 110 extracts the parameter for obtaining the automatic display value computed by the detector 170, in step 401. In step 401, the controller 110 extracts both the max number by which a user has inputted the right direction key and the average time, for which the right direction key is input, from the extracted parameter. In step 402, the controller 110 initializes a Shift Number (SN) for checking the number of times of shift as “0”.

In a state where the enlarged partial section of the document corresponding to the start area of the first line within the document has been displayed in the automatic display mode, the controller 110 determines if the average time passes. If the average time passes, the controller 110 detects the passage of the average time in step 403, and generates a right direction key event, automatically shifts the cursor rightward by the predetermined number of pixels, does not display left characters/numerals displayed by the predetermined number of pixels, and displays right characters/numerals having not been displayed, thereby displaying the corresponding enlarged partial section of the document, in step 404.

In step 405, the controller 110 determines if the shift number coincides with the max number. As a result of the determination, if the shift number does not coincide with the max number, the controller 110 increases the shift number by “1” in step 406.

The controller 110 controls the characters/numerals, which have been displayed as the enlarged partial section of the document of the first line, to be automatically shifted and displayed through the repetition of steps 403 to 406. If the shift number coincides with the max number during the repetition of the steps, the controller 110 detects that the last area of the first line is reached in step 405, and generates an event for shift to the start area of the subsequent line in step 408.

In step 408, the controller 110 initializes the shift number as “0”, generates a left event key by the max number for shifting to the start area again, generates a down key event for shifting to the subsequent line, and thereby controlling display of the enlarged partial section of the document corresponding to the start area of the subsequent line, in step 409.

Thereafter, the controller 110 controls the whole content of the currently displayed document to be automatically shifted to the enlarged partial section of the document and to be displayed through the repetition of steps 403 to 409. If the last area of the last line within the document is reached during the repetition of the steps, the controller 110 detects that the last area of the last line has been reached, and ends the automatic display mode.

In the present invention, the automatic display method of the document, in which characters and numerals written from left to right are displayed line by line, is described as an example. However, the present invention can also be applied to a case of a document, in which characters and numerals written from top to bottom are displayed column by column, in the same manner. Further, in the present invention, only the automatic display method of the document including characters and numerals is described. However, the present invention can also be applied to a case in which image data including photographs are enlarged and displayed, in the same manner, so that an automatic display mode can operate.

According to the present invention as described above, an enlarged partial section of a document output to a wireless terminal is automatically shifted and displayed, so that an automatic display mode can be set depending on user's selection. Further, it is possible to reduce inconvenience where a user must innumerably and repeatedly input a direction key in the automatic display mode. Furthermore, since each user reads a document at different rate, the document is automatically displayed according to the reading rate of each user. Consequently, each user can more conveniently read the document.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for automatically displaying data in a wireless terminal, the method comprising the steps of:
displaying selected data;
when the data are enlarged and displayed as partial data, extracting an automatic display value for displaying the partial data enlarged through automatic shift; and
automatically displaying the automatically shifted and enlarged partial data through the automatic display value.

2. The method as claimed in claim 1, wherein the step of extracting the automatic display value further comprises:
displaying corresponding enlarged partial data after shifting to a start area of a predetermined line within the data;
if a shift key is input, determining if a last area of the line is reached;
if the last area of the line is not reached, displaying corresponding partial data enlarged during shifting in a predetermined direction, which corresponds to input of the shift key, by a predetermined unit;
if the last area of the predetermined line is reached, extracting both total time, which is required for shifting from the start area to the last area, and a maximum number of the shift key; and
extracting average time, for which the shift key is input, through both the total time and the maximum number of the shift key.

3. The method as claimed in claim 2, wherein the predetermined line corresponds to a longest line among lines constituting the data.

4. The method as claimed in claim 2, wherein the shift key corresponds to one of direction (up/down/left/right) keys.

5. The method as claimed in claim 1, wherein the step of automatically displaying further comprises:
a) exacting the average time, for which the shift key is input, and the maximum number of the shift key through the automatic display value;
b) initializing a shift number for checking a number of times of shift of the enlarged partial data;
c) determining if the average time passes;
d) if the average time passes, generating an event of the shift key, thereby displaying the corresponding partial data automatically shifted and enlarged in a direction corresponding to the shift key;
e) determining if the maximum number of the shift key coincides with the shift number;
f) if the maximum number of the shift key does not coincide with the shift number, increasing the shift number, and automatically displaying a current line as the corresponding enlarged partial data through repetition of the steps c) to e); and
g), if the maximum number of the shift key coincides with the shift number, generating an event for shifting to a start area of a subsequent line, and repeating steps c) to f).

6. The method as claimed in claim 5, wherein step a) is performed in a state where the corresponding partial data enlarged after shifting to a start area of a predetermined line selected from data for the automatic display have been displayed.

7. The method as claimed in claim 5, wherein step g) further comprises:
if the maximum number of the shift key coincides with the shift number, determining if a last line of the data is reached;
if the last line is not reached, initializing the shift number, generating a key event, which is inverse to the shift key, by the maximum number of the shift key for shifting to a start area of the current line, generating a key event for shifting to the subsequent line, and shifting to a start area of the subsequent line;
repeating steps c) to f) in the start area of the subsequent line; and
if the last line is reached, ending the automatic display of the data.

8. The method as claimed in claim 1, wherein the data correspond tone of document data and image data including characters and numerals.

9. A method for automatically displaying document data in a wireless terminal, the method comprising the steps of:
enlarging a selected document in the wireless terminal and displaying enlarged partial section of the document;
extracting an automatic display value required for reading a longest line in the enlarged partial section of the document; and
automatically displaying the enlarged partial section of the document through automatic shift by means of the automatic display value.

10. The method as claimed in claim 9, wherein the step of extracting the automatic display value further comprises:
if an automatic display setup mode is selected, displaying the corresponding enlarged partial section of the document after shifting to a start area of the longest line;
if a right direction key is input, determining if a last area of the longest line is reached;
if the last area of the longest line is not reached, displaying the corresponding enlarged partial section of the document during shifting in a right direction by a predetermined unit;
if the last area of the longest line is reached, extracting both total time, which is required for shifting from the start area to the last area, and a max number of the right direction key; and
extracting average time, for which the right direction key is input, through both the total time and the max number of the right direction key.

11. The method as claimed in claim 9, wherein the step of automatically displaying further comprises:
a) shifting to a start area of a first line in the document, and displaying the corresponding enlarged partial section of the document;
b) if an automatic display mode is selected, exacting both an average time, for which the right direction key is input, and a maximum number of the right direction key through the automatic display value;
c) initializing a shift number for shift of the enlarged partial section of the document;
d) step of determining if the average time passes;
e) if the average time passes, generating an event of the right direction key, thereby displaying the corresponding enlarged partial section of the document through automatic shift in a right direction by a predetermined unit;
f) determining if the maximum number of the right direction key coincides with the shift number;
g) if the maximum number of the right direction key does not coincide with the shift number, increasing the shift number, and automatically displaying a current line as the corresponding enlarged partial section of the document through repetition of the steps d) to f); and
h) if the maximum number of the right direction key coincides with the shift number, generating an event for shifting to a start area of a subsequent line, and repeating steps d) to g).

12. The method as claimed in claim 11, wherein step h) further comprises:
if the maximum number of the right direction key coincides with the shift number, determining if a last line of the document is reached;
if the last line is not reached, initializing the shift number, generating an event of a left direction key by the maximum number of the right direction key for shifting to a start area of the current line, and generating an event of a down direction key for shifting to a start area of a subsequent line;
repeating steps d) to g) in the start area of the subsequent line;
if the last line is reached, ending the automatic display of the document.
